(19) United States
(12) Patent Application Publication
(10) Pub. No.: US 2013/0316820 A1
(43) Pub. Date: Nov. 28, 2013

(54) Revolution Take Over 3D

(71) Applicant: Sparkle Douglas, Brooklyn, NY (US)

(72) Inventor: Sparkle Douglas, Brooklyn, NY (US)

(21) Appl. No.: 13/851,049

(22) Filed: Mar. 26, 2013

Related U.S. Application Data
(60) Provisional application No. 61/685,870, filed on Mar. 26, 2012.

(51) Int. Cl. A63F 13/00

(52) U.S. Cl. CPC A63F 13/00
USPC 463/31

(57) ABSTRACT

The invention provides a unique gaming system for home use that incorporates technologically advanced virtual reality and three dimensional aspects. The three essential components that comprise the present invention are a multifaceted helmet, outfitted game gloves and controllable kneepads. The helmet is worn about the face to cover the eyes and ears and is the master control center of the game system. A handy insert located on the back of the helmet accepts game cartridges, CDs and Blu Ray DVDs containing games.

### CLAIM OF PRIORITY

This patent application claims priority under 35 USC 119 (e) (1) from U.S. Provisional Patent Application Ser. No. 61/685,870 filed Mar. 26, 2012, of common inventorship herewith entitled, “Revolution Take Over 3D.”

### FIELD OF THE INVENTION

The present invention pertains to the field of electronic games, and more specifically to the field of video gaming systems.

### BACKGROUND OF THE INVENTION

The prior art has put forth several designs for video gaming systems. Among these are:

U.S. Pat. No. 5,423,554 to Geoffrey M. Imis describes a one or two player virtual reality game that detects and tracks a distinctively colored glove. According to the preferred basketball embodiment, a single player equipped with the distinctively colored glove is matched up against a virtual opponent. The object of the game is for the real player to put a virtual basketball into a virtual basketball hoop before his/her virtual opponent steals the ball. The background site is scanned initially and then the operator with the glove is scanned. A table of colors then is established which are unique only to the glove. A player is scanned against the background to identify which color glove has the least conflict with colors worn by the player. During play, the player is scanned at 30 frames a second and the information is stored in a frame buffer. A prediction is made of the location of the glove in subsequent frames based upon its previously known location and velocity. A search for the glove is made of a limited portion of the full frame, increasing the speed of acquisition. Gestures made by the player such as a flick shot, a dribble or a roundhouse shot are distinguished to automatically cause the basketball to be released from the player's hand. If the velocity and direction of the ball are substantially in the direction of the virtual basketball hoop, the player is credited with a score.

U.S. Pat. No. 6,054,991 to Christopher Adam Crane, Tom J. Bannon, Daniel Martin Donahue, Donald Wayne Adkins, Judd England Heape, Andrew Kendall Smith and Thomas M. Siep describes a method of modeling player position and movement in a virtual reality system. In a virtual reality system an operator perceives being in a virtual reality world of virtual reality images. The system models the relative position and movement of objects in a virtual reality world by representing graphically a first and second object in a virtual reality world on a graphical display. The representation selectively obscures the first and second objects according to the relative position of the objects to a predetermined observation point in the virtual reality world. The system then determines a first partitioning plane between the first and second objects. The system method next determines a second partition plane between the first and second object in response to either of said first or second objects moving across the first partitioning plane. The system then graphically represents on the graphical display the first and second objects within the virtual reality world by selectively obscuring the first and second objects according to their relative position to the predetermined observation point.

U.S. Pat. No. 7,225,414 to Rajeev Sharma, Emilio Schapira and Namsoon Jung describes a method and system for virtual touch entertainment. This VTE or Virtual Touch Entertainment Platform attracts people in public places and engages them in a touch free interaction with a multimedia display using an image capturing system and a set of Computer Vision algorithms as a means of informing the public as well as collecting data about the users. The VTE Platform comprises a series of interaction states such as the Wait State, the Attraction State, the User Engagement State, the User Interaction State and the Interaction Termination State. The modules in these interaction states handle complicated tasks assigned to them such as attracting the users, training the users, providing the multimedia digital content to the users and collecting the user data and statistics in an efficient and intelligent manner. The user experiences a whole new interaction paradigm while getting information and entertainment through the rich digital multimedia. The system operates automatically and dynamically in real time throughout the whole interaction process.

None of these prior art references describe the present invention.

### SUMMARY OF THE INVENTION

It is an object of the present invention to provide an improved video gaming system comprising a novel virtual reality headpiece.

### BRIEF DESCRIPTION OF THE DRAWINGS

FIG. 1 is an illustrative functional view showing a visor face mask that slides down when on, gloves that control arm movement, knee pad sensors that control leg movement, and detachable cables that run from the gloves to the knee pads.

FIG. 2 is an illustrative functional view showing an example display as viewed inside the visor and how a player can see a game in 3D and use gloves and knee pads for game movement.

FIG. 3 shows is a zoom side view of a head helmet showing a game insert for CDs, earphones, and a slide up and down visor that activates the system when wearer slides the visor.

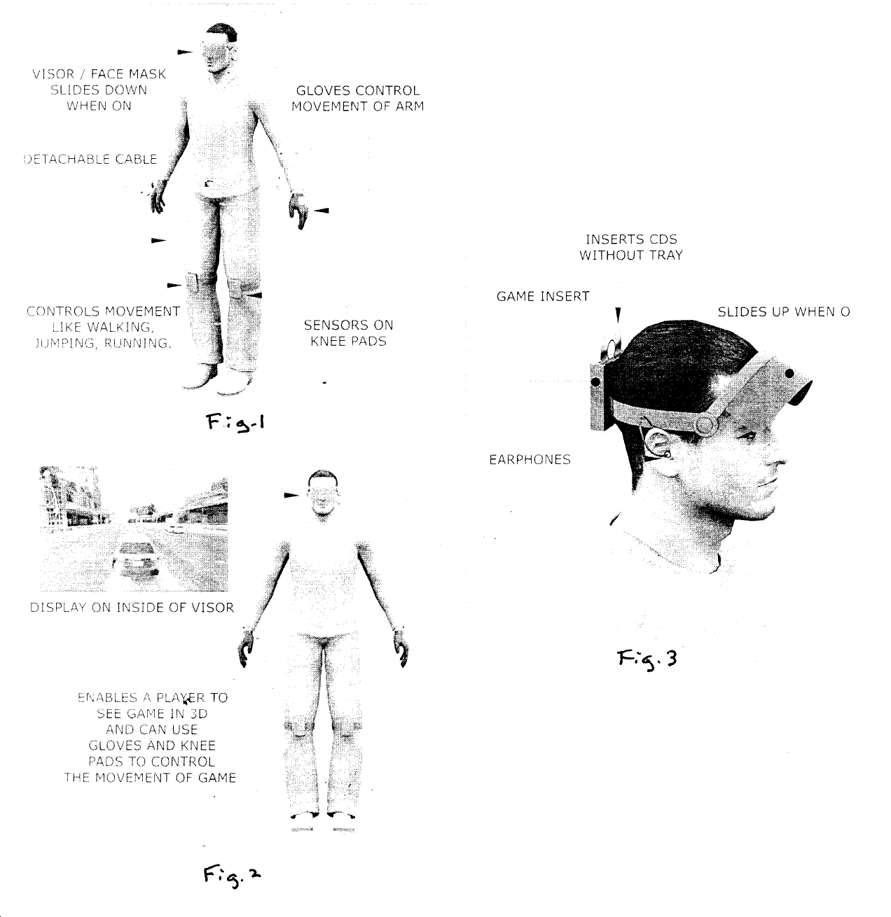

### DETAILED DESCRIPTION OF THE INVENTION

First mass marketed approximately forty years ago, video games are played by installing cartridges into a game box which is connected by wire to a television set. Using a joystick or buttons, a player manipulates the actions of characters as they face obstacles displayed on the screen. Video games are designed chiefly to appeal to children and adolescents and may be played in arcades and on small handheld screens. Popular game systems such as Nintendo and Sony are present in many homes today. Many children have been exposed to some form of video games and access to the games is readily available in all walks of life. In addition to the consoles that play games in cartridge or CD ROM format, the advent of the Internet opened a whole new world of interactive gaming. Players can use their personal computers to engage in competitions with people all over the world. In addition to adolescents, adults are increasingly playing computer and video games.

The present invention, hereinafter referred to as the Revolution Takeover 3D, is a unique gaming system for home use that incorporates technologically advanced virtual reality and three dimensional aspects. The three essential components that comprise the present invention are a multifaceted helmet, outfitted game gloves and controllable kneepads. The helmet is worn about the face to cover the eyes and ears and is the master control center of the game system. A handy insert located on the back of the helmet accepts game cartridges, CDs and Blu Ray DVDs containing games. The Revolution Takeover 3D is compatible with existing gaming systems such as PlayStation Two and Three as well as Nintendo's Wii. With this compatibility, the present invention plays popular sports games, Dance Dance Revolution, Grand Theft Auto and other perennial favorites. The lenses in the helmet provide the system's visual screens and display the action of the game being played. Each side of the helmet contains a handy earphone assembly to provide an avenue for the audio component of Revolution Takeover 3D. The helmet also has a receiver apparatus which works with transmitting sensors located in each of the gloves and the kneepads. Covering the hands in the same manner as standard gloves, the Revolution Takeover 3D gloves contain sensors in each of the fingers. These sensors control the action taking place on the helmet's display screen. A coiled cable joins the gloves to the kneepads which also have sensors for transmitting leg action to the helmet.

In an embodiment, also enclosed is an A/C adapter useful for charging the system.

Virtual reality is a technology which allows a user to interact with a computer simulated environment whether real or imagined. Most current virtual reality environments are visual experiences displayed either on a computer screen or through special or stereoscopic displays. Some simulations include additional sensory information such as sound through speakers or headphones. In medical and gaming applications, some advanced haptic systems include tactile information known as force feedback. Users interact with a virtual environment or virtual artifact through using standard input devices such as a keyboard and mouse or through using multi modal devices such as a wired glove, a Polhemus boom arm and an omnidirectional treadmill. The simulated environment may be similar to the real world as in simulations for pilot or combat training, or the simulated environment may differ significantly from reality as in VR games. Creating a high fidelity virtual reality experience is very difficult, due largely to technical limitations on processing power, image resolution and communication bandwidth. As processor, imaging and data communication technologies become more powerful and cost effective, these limitations will be resolved.

Revolution Takeover 3D is an innovative product invention that allows game players to virtually enter the many worlds offered by video technology. Easily activated, this exciting game system effectively fosters camaraderie and competition among users of all ages. Affordably priced, Revolution Takeover 3D is well received by the vast number of consumers who enjoy playing interactive video games, a very sizable market potential.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A video gaming system video gaming system device comprising a novel virtual reality headpiece, comprising: a multifaceted helmet, outfitted game gloves and controllable kneepads, wherein the helmet is worn about the face to cover the eyes and ears and is the master control center of the game system, wherein an insert located on the back of the helmet accepts game cartridges, CDs and Blu Ray DVDs containing games.

2. The video gaming system video gaming system device of claim 1, wherein the device is compatible with existing gaming systems such as PlayStation Two and Three as well as Nintendo's Wii.

3. The video gaming system video gaming system device of claim 1 wherein the helmet comprises lenses in the helmet to provide the system's visual screens and display the action of the game being played, and wherein each side of the helmet contains an earphone assembly to provide audio input.

4. The video gaming system video gaming system device of claim 1 wherein the helmet comprises a receiver apparatus which works with transmitting sensors located in each of the gloves and the kneepads.

5. The video gaming system video gaming system device of claim 1 wherein the gloves comprise sensors in each of the fingers, wherein the sensors control action taking place on the helmet's display screen.

6. The video gaming system video gaming system device of claim 1 wherein the kneepads have sensors for transmitting leg action to the helmet.

7. The video gaming system video gaming system device of claim 1 wherein a coiled cable joins the gloves to the kneepads.

8. The video gaming system video gaming system device of claim 1 further comprising an A/C adapter for charging the system.
